(19) United States
(12) Patent Application Publication
(10) Pub. No.: US 2002/0059395 A1
(43) Pub. Date: May 16, 2002

(54) User interface for online product configuration and exploration

(76) Inventor: Shih-Ping Liou, West Windsor, NJ (US)

Correspondence Address: Siemens Corporation, Intellectual Property Department, 186 Wood Avenue South, Iselin, NJ, 08830, US

(21) Appl. No.: 09/908,934

(22) Filed: Jul. 19, 2001

Related U.S. Application Data
(60) Provisional application No. 60/219,197, filed on Jul. 19, 2000.

(51) Int. Cl. G06F 7/00

(52) U.S. Cl. 709/217; 705/26; 707/3

(57) ABSTRACT

A system and method for providing a user interface for product exploration and product configuration in which a seamless integration of browsing, query, and human assistance is provided which is customized to the knowledge level of each individual user. Product information is displayed on a web site under multiple views represented by a tab on the user interface. If the user is not familiar with a web site's layout, s/he can type in a query, and documents based on relevance to the entered query will be returned. Relevance indicators are provided to indicate a relevance of each view, for each sub-category under a view, and a degree of relevance of the returned documents based on the user query. Actions of each user are summarized in a user summary, wherein if the user clicks on a help button provided on the user interface, said user summary is displayed to an agent.

This is a non-provisional application claiming the benefit of provisional application Ser. No. 60/219,197 entitled, User Interface For Online Product Configuration and Exploration, filed Jul. 19, 2000, which is hereby incorporated by reference.

### BACKGROUND

1. Technical Field

The present invention relates generally to graphical user interfaces for product configuration and exploration. More specifically, the present invention relates to a system and method for integrating a variety of search information and generating multiple views of a product and/or product collection to facilitate accurate and effective access of information over an electronic network.

2. Description of Related Art

The worldwide acceptance of the Internet represents a turning point in electronic business by providing an easy-to-use technological solution to the problem of information publishing and dissemination. As the electronic business market grows, more and more customers are able to get instant access over the World Wide Web to information regarding various products, services, and even their own words. In addition, customers can compare and shop globally around the clock.

Access to such a plethora of information facilitates comparison shopping, which means a business customer could very easily change suppliers. As a result, customer loyalties have become harder to win. For many companies, the challenge is becoming how to provide high quality personalized customer services to not only retain customers but to attract new customers as well.

Personalized customer services can best be realized by establishing trusted relationships between a business and its customers. In such a relationship, customers will always be able to count on the customer support center for satisfying their needs. This, however, requires investment in staffing and retaining sufficient numbers of experienced human agents to staff customer support centers. Given the fluctuating nature of customer requests, it is extremely difficult for any business to control the personnel cost of offering such services.

The World Wide Web is a powerful medium which makes it possible to offer such personalized services with a minimum use of personnel resources. Various companies offer software which enables online customers to obtain product information and conduct transactions without the involvement of human agents. Despite the advancement of personalization and knowledge management technologies however, it is still difficult for customers to quickly access relevant and accurate information, whether it is related to products or services, due to an often overwhelming amount of information provided. Existing solutions are useful only when the navigation structure is simple and visitors are familiar with the content. Usually, the problem is not in the availability of relevant information but, rather, its accessibility. Whether it is a prospective customer interested in product information, or an existing customer accessing online help and/or service information, their primary goal is to access relevant and accurate information as quickly as possible.

Most business web sites offer three independent modes for accessing product information: browsing, query, or human assistance modes. In the browsing mode, navigation aids such as trees, tabs, and lists are provided and the user is expected to find his way through the given navigation structure. This is possible only when the user understands the product line. In the query mode, the user enters a query and is then presented with a list of relevant documents in the order of their relevance. If the user is lucky, some of the top documents in the list may be relevant to his/her needs. If not, s/he may be forced to either wade through a long list of the remaining documents or simply give up. Finally, some web sites may offer a “Call Expert” button to access a human expert, but the user must explain everything from the beginning in order to be assisted, which is time-consuming and only adds to his/her frustration.

Once a user decides which product to buy, most business web sites offer only standard configurations of each product to try to simplify the presentation of information for users. Some sites offer a product configurator for sophisticated users, however, in this case, users are expected to provide an answer for each of a series of detailed questions. Often several rounds of trial and error are required before users can finalize their product configuration. A typical example of this online product configurator are reservation systems offered by online travel agencies, in which users are expected to know detailed information in advance such as the date and time of travel, destinations, etc., in order to finalize their travel itinerary.

The above problems due to inefficient and ineffective product exploration and product configuration cannot be solved by current personalization technologies based on information such as customer profiles, community statistics, and customer records. These personalization features create dynamic customized web pages, and provide personalized navigation support. However, they offer little or no help in situations where users only have vague or ill-defined ideas about what they would like to buy, when they do not completely comprehend the product line, or when they are not familiar with the terminology used by the business. In addition, although a particular web site may be personalized to some extent for a particular user, there is often still much more information (for example, about products) than a typical user needs.

Accordingly, an efficient and effective data search technique for providing improved product exploration and configuration to provide users with relevant and accurate information, is highly desirable.

### SUMMARY OF THE INVENTION

The present invention provides an improved user interface for product exploration and product configuration in which a seamless integration of browsing, query, and human assistance is provided which is customized to the knowledge level of each individual user.

Advantageously, since product information is available via multiple views in the present invention, a user is able to browse using views appropriate for his/her needs. Each view may be represented by a tab on the user interface. Each tab may be comprised of various colors according to the relevance of the documents under each tab (view) with respect to the entered query. In addition, relevance indicators are provided for each sub-category under a view, which the user can use as a guide to quickly navigate to a sub-category which has the most relevant documents.

If the user is still not familiar with a website's layout, s/he can type in a query. The system then orders documents based on relevance to the entered query. Unlike commercial search engines, a system according to the present invention utilizes the structure of indexes and the user's profile and context information, to produce effective results. For example, a user may indicate in his/her profile that certain areas of information are not of interest, and the system will display any documents under those areas in, for example, a de-emphasized manner. Thus, users avoid looking at documents which are not consistent with their profile.

Overall, a user interface for product exploration and configuration according to the present invention: 1) offers different users different sets of views, each of which provides a unique and independent perspective of the product line or product information, 2) maps information from one view to other views to facilitate selective refinement while browsing, and 3) summarizes the intention and knowledge level of users to human agents, thus providing seamless transition from self-help mode to agent-assistance mode without the need for users to explain everything from the beginning.

A user interface according to an aspect of the present invention includes a hypertext browser coupled with a multi-view product browser and a query interface. The hypertext browser is used to display search/browsing results as well as to browse product catalogs or an information space such as, for example, the World Wide Web.

The multi-view product browser allows users to see how a selected list of products or product information maps to different but independent perspective of their concerns (views), each of which is represented by a tab. Users can expand or shrink this list of products/product information by entering a search query, and/or selecting or deselecting sub-categories under a view. Sub-categories may be displayed, for example, as a hierarchical tree structure, an image map, a 3D model, etc. Each view provides a unique and independent user perspective of the product content.

Advantageously, users can start product exploration or configuration from the view they find easiest to understand or move from one view to another as they gain an understanding. A system according to the present invention advantageously offers users the ability to find products or product information accurately and effectively, even though the user only has vague or ill-defined ideas about what he/she would like to buy, does not completely comprehend the product line, or is not familiar with the terminology used by the business. In each view, users may select/deselect various sub-categories, which in turn may increase or decrease the space of selected product content.

In one aspect of the present invention, a system for accessing information is provided comprising: a server system comprising a product database; a user profile database for storing user profiles; and a domain model for modeling a set of views associated with product information stored in the product database, wherein said product database, the user profile database and the domain model are stored in a storage device; and a client system comprising a multi-view product browser for rendering a set of views stored in the storage device, each view comprising a perspective of product data, said product data being organized under sub-categories under each view, wherein as the user searches through the set of views, the multi-view product browser maps information from each view to other views for refining said information; and a hypertext browser for generating relevant data from said product data based on at least one of a user query, domain knowledge, and the user profile, wherein a degree of relevance is reflected for each view, the sub-categories under each view and the relevant data with respect to the user query.

In another aspect of the present invention, a method of accessing information comprising the steps of: rendering a set of tabs on a user interface, each tab comprising a perspective of product data, wherein said product data is organized under sub-categories under each tab; generating relevant documents from said product data with respect to a user query, wherein a degree of relevance is reflected for each tab, the sub-categories under each tab, and the relevant documents with respect to the user query; and locating the relevant documents under the set of tabs, wherein as a user searches through the set of tabs, information from each tab is mapped to other tabs for refining the relevant documents.

In yet another aspect of the present invention, a method of accessing information comprising the steps of rendering a set of tabs on a user interface, each tab representing a perspective of information of a product line, wherein as a user searches through the set of tabs, information from each tab is mapped to other tabs for refining said information; and summarizing actions of each user in a user summary, wherein if the user clicks on a help button provided on the user interface, said user summary is displayed to an agent.

These and other aspects, features and advantages of the present invention will become apparent from the following detailed description of preferred embodiments, which is to be read in connection with the accompanying drawings.

### BRIEF DESCRIPTION OF THE DRAWINGS

FIG. 1 illustrates an exemplary user interface window according to an embodiment of the present invention.

FIG. 2 depicts an exemplary user interface window in which a user query is entered according to an embodiment of the present invention.

FIG. 3 shows an exemplary user interface window in which a relevant document is mapped into the multi-view product browser according to an aspect of the present invention.

FIG. 4 depicts an exemplary user interface window in which the hypertext browser returns a list of relevant product documents with respect to the sub-category “Filling and Dosing” according to an aspect of the present invention.

FIG. 5 is an exemplary user interface in which the relevant product documents are mapped into a different view according to an aspect of the present invention.

FIGS. 6-9 are exemplary user interfaces for showing how a list of relevant product information is mapped into various views according to an aspect of the present invention.

FIG. 10 depicts an exemplary block diagram depicting a method for updating the relevance of each sub-category and each view.

FIG. 11 depicts an exemplary user summary window showing user intention and knowledge level, which is displayed on the screen of a human agent when a user requests for either anonymous help or in-person help.

### DETAILED DESCRIPTION OF PREFERRED EMBODIMENTS

It is to be understood that the exemplary system modules and method steps described herein may be implemented in various forms of hardware, software, firmware, special purpose processors, or a combination thereof. Preferably, the present invention is implemented in software as an application program tangibly embodied on one or more program storage devices. The application program may be executed by any machine, device or platform comprising suitable architecture. It is to be further understood that, because some of the constituent system modules and method steps depicted in the accompanying Figures are preferably implemented in software, the actual connections between the system components (or the process steps) may differ depending upon the manner in which the present invention is programmed. Given the teachings herein, one of ordinary skill in the related art will be able to contemplate or practice these and similar implementations or configurations of the present invention.

In the following description, numerous specific details are set forth in order to provide a thorough understanding of the present invention. In other instances, well known process steps have not been described in detail in order not to unnecessarily obscure the present invention.

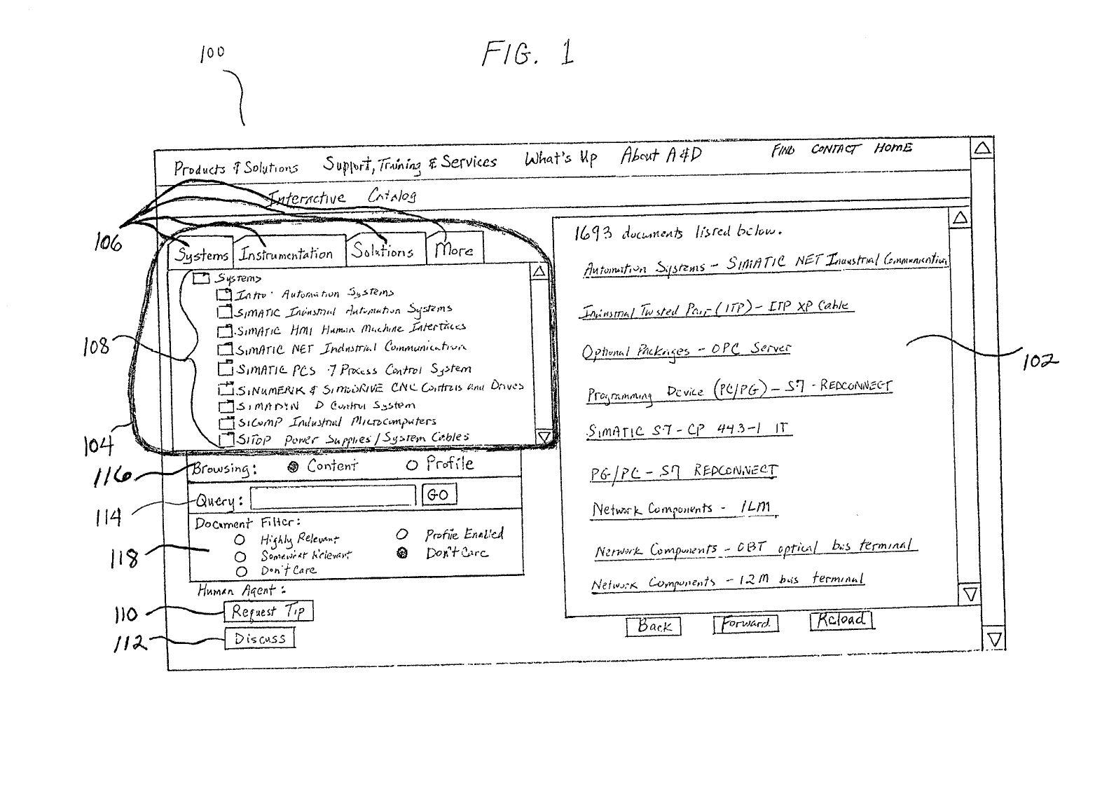

FIG. 1 illustrates an exemplary user interface window 100 according to an embodiment of the present invention. User interface window 100 comprises a hypertext browser 102 (which can be, for example, a hypertext markup language browser) for displaying browsing results to browse product information (catalogs) or an information space such as the World Wide Web. In addition, the hypertext browser can display search results in response to a user query, and/or also take into account the user profile information and domain knowledge.

A multi-view product browser 104 allows users to see how, for example, a selected list of product information maps to various independent perspectives of their concerns (views) 106, each of which is represented by a tab or a “hotspot”. Each view 106 provides a unique and independent user perspective of product data (e.g., unique and independent perspectives of each product line or product information). For example, here there are four views: “Systems”, “Instrumentation”, “Solutions”, and “More”. Each of these views includes sub-categories 108 which provide more detailed information about each view. The sub-categories can be displayed, for example, as a hierarchical tree structure, an image map, a 3-D model, etc. For example, if the “Systems” tab is selected, a hierarchical tree structure (as shown here by sub-category 108) may be displayed.

It is to be noted that the views may be rendered based on the user profile, community statistics and/or historical data. Community statistics may comprise, for example, a user's characteristics such that the user can be characterized based on his/her preferences to belong a particular group of people. Historical data may comprise, for example, past actions of the user while on the website.

The user interface may also include a browsing format selector 116 in which the user may select a browsing format based on, for example, the site's content or the user's profile. Here, the browsing format selector 116 is set on, for example, “content” which presents the user interface 100 in a browsing format based on the web site's content. Alternatively, it is to be appreciated that the user interface 100 may be presented in, for example, a format according to a user profile by setting the browsing format selector to “profile”.

In a preferred embodiment, the user interface 100 also allows users to discuss their specific needs and/or problems with a human agent by seeking either anonymous help or in-person help. For example, the user interface includes a Request Tip button 110 for requesting anonymous help, in which a human agent is asked to try to find useful/relevant information pertaining to the user's customer actions summary. If the human agent is successful, s/he then directs any relevant web content to be displayed on the user's screen.

The user interface 100 includes a Discuss button 112 for requesting in-person help in which an online web conference session is invoked between the user and a human agent. Unlike the anonymous mode where a user receives anonymous help (without the need to identify him/herself), the in-person mode offers live/interactive help over the Internet. Both the Request Tip button and the Discuss button offer a seamless transition from a self-help mode to an agent-assisting mode. In both the anonymous help and in-person help cases, a human agent on a business site receives a call from a user, reviews a customer actions summary generated by the server and displayed on the agent's screen, and then tries to assist the user who made the request based on the information shown in the customer summary.

User interface 100 also includes a query interface 114 where a user may enter a search query to expand or narrow down the amount of product information according to the user's particular interests. A document filter interface 118 may also be provided to filter a list of returned documents (product information) according to, for example, whether they are highly relevant, somewhat relevant, or with respect to a user profile.

In a preferred embodiment, the tabs of each view 106 can have different color shades according to each view's relevance with respect to, for example, an entered search query.

Advantageously, users can start product exploration or configuration from the view they find easiest to understand, and can move from one view to another while the information of each view is mapped seamlessly into a next view.

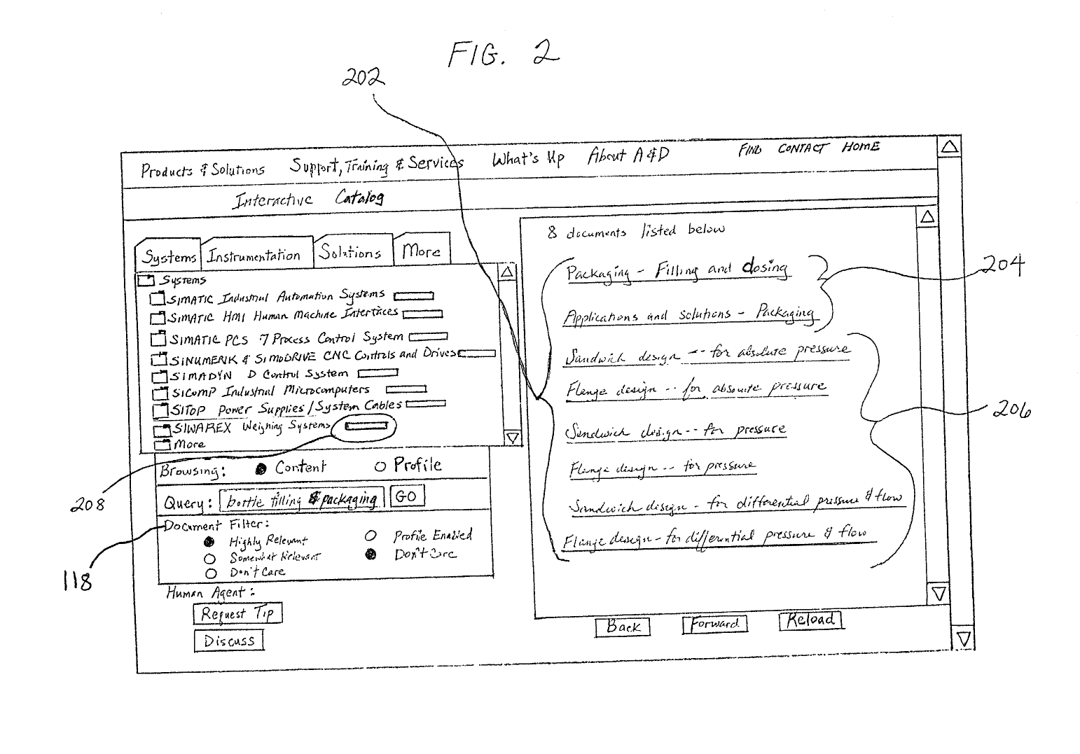

FIG. 2 depicts an exemplary user interface window 200 in which a user query is entered according to an embodiment of the present invention. Here, for example, a search query “bottle filling and dosing” is entered in the query interface 114. Results of the search pertaining to the search query are displayed by the hypertext browser 102 as selected product information 202. Preferably, the selected product information 202 is separated into, for example, two different categories indicating, for example, “important” 204 or “less important” 206 information. Preferably, the different categories are distinguished in some way, for example, they can be highlighted in two different colors or written in different fonts.

In addition, a relevance bar indicator 208 is preferably provided to indicate the relevance of each of the sub-categories 108 with respect to the entered search query. The relevance indicator may comprise, for example, a horizontal bar (as illustrated by 208) which can be shaded/colored in to show a ratio of relevant product information with respect to all product information indexed under each sub-category. For example, the amount which the bar is shaded in can reflect a ratio of that sub-category's importance with respect to the search query, e.g., a bar with a larger portion of shaded/colored space indicates that the sub-category it represents is more relevant to the search query than a bar with a smaller portion of shaded/colored space.

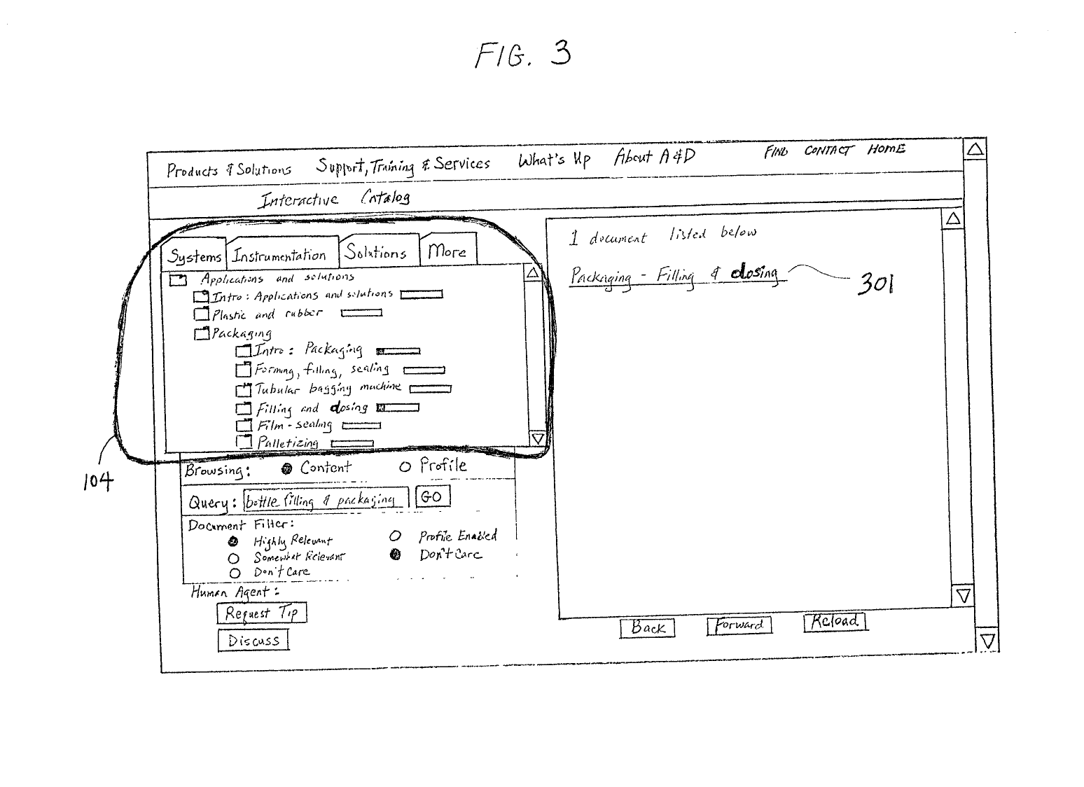

FIG. 3 shows an exemplary user interface window in which a relevant document 301 is mapped into the multi-view product browser 104 according to an aspect of the present invention. Here, for example, the document “Packaging Filling and Dosing” is under the “Solutions” view. The relevance indicators demonstrate an increased relevance of the “Intro: Packaging” and “Filling and Dosing” sub-categories.

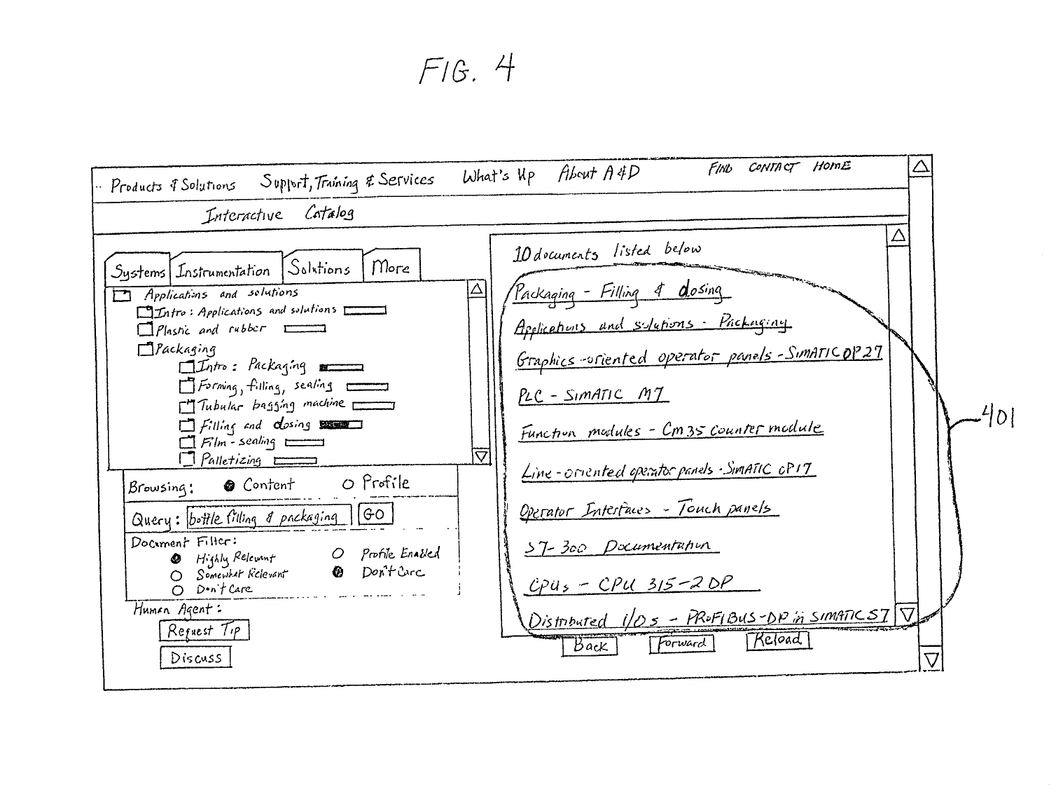

The user may then for example, set the sub-category “Filling and Dosing” as relevant. The system will then automatically add all documents indexed under “Filling and Dosing”, even though they were not initially included in the list of all relevant documents. FIG. 4 depicts an exemplary user interface window in which the hypertext browser 102 returns a list of relevant product documents 401 with respect to the sub-category “Filling and Dosing” according to an aspect of the present invention. Here, there are, for example, ten relevant product documents 401.

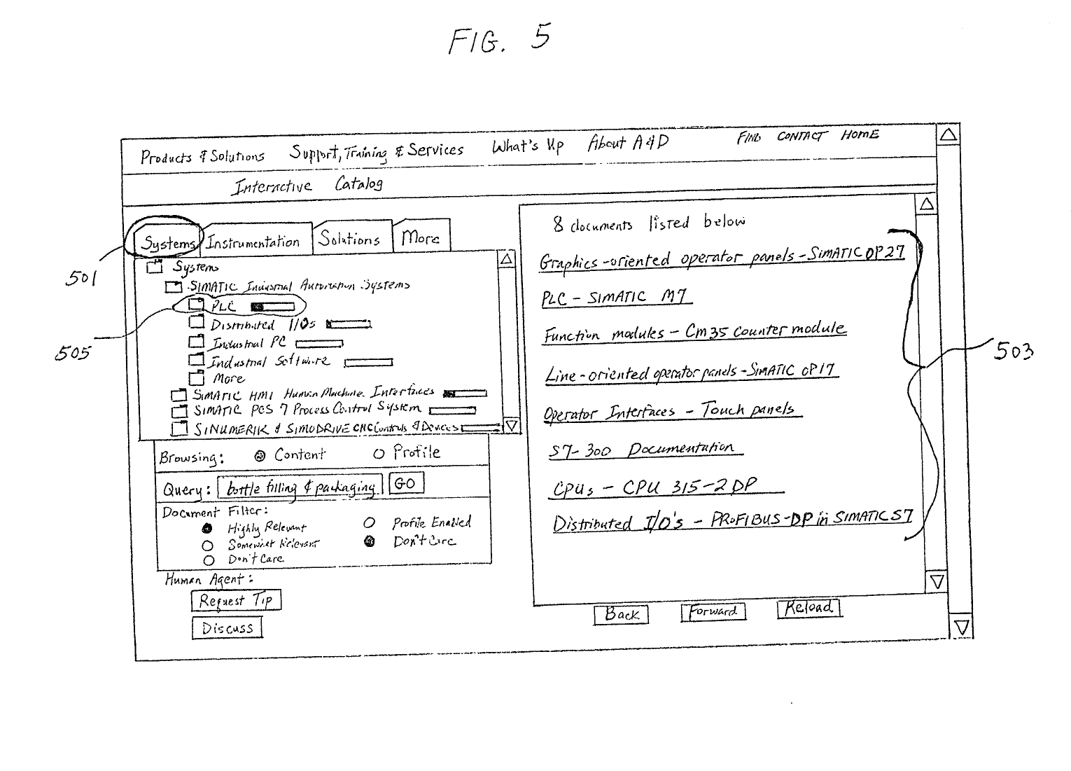

FIG. 5 is an exemplary user interface in which the relevant product documents 401 are mapped into a different view 106 according to an aspect of the present invention. For example, here, the relevant documents 401 are mapped onto the “Systems” view 501, thus narrowing the list 401 to 8 documents 503 which are both relevant to the entered user query “Bottle filling and packaging” and which fall under the “Systems” view 501.

The user may then view documents under each sub-category of the mapped view, using, for example, the relevance indicators 208 as a guide for indicating the most relevant sub-categories. For example, in FIG. 5, the PLC sub-category 505 has a relevance indicator which indicates that it contains a particular ratio of relevant documents that fall under the PLC sub-category. The relevant PLC documents will be displayed by the hypertext browser as a result of selecting the PLC sub-category 505.

The present invention also offers a custom brochure feature in which a user may indicate which documents he is interested in as he explores the website, and these documents of interest will be “collected” (for example, for a group printout at a later time). Advantageously, since the present invention includes information which links these collected documents to their respective sub-categories, the custom brochure feature can automatically generate a “table of contents” which links to the collected documents being selected by the user. This table of contents (e.g., list of respective sub-categories) organizes the selected documents and allows the user to see how his separate selected documents of interest relate to each other.

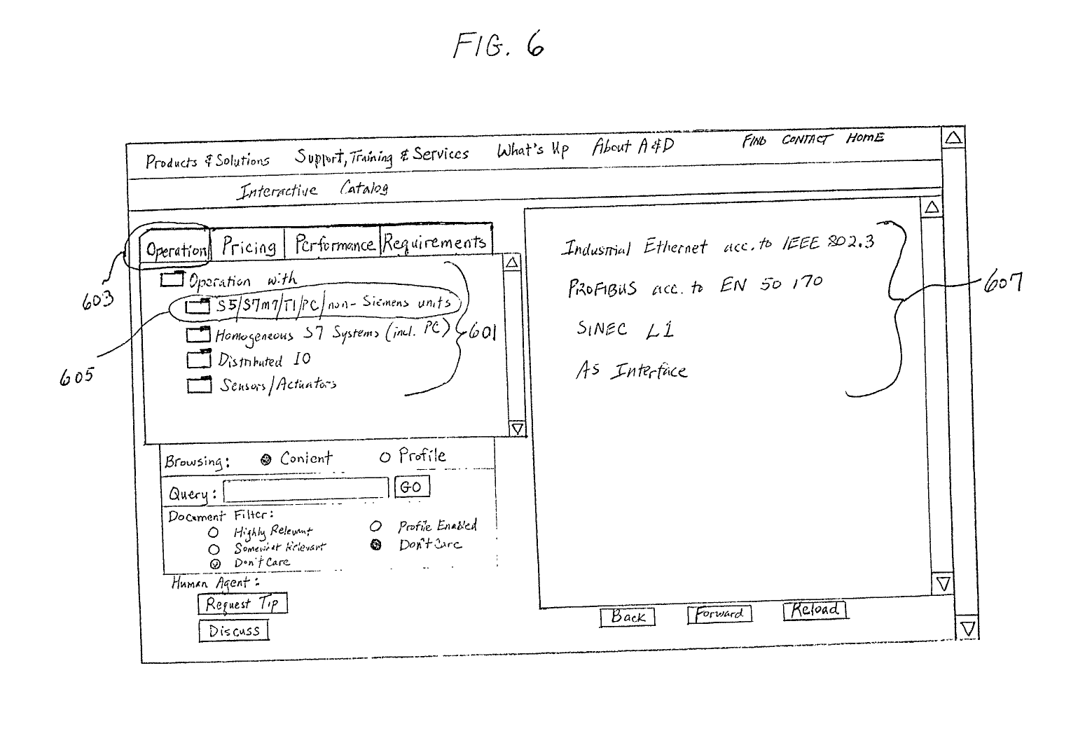

FIGS. 6-9 are exemplary user interfaces for showing how a list of relevant product information is mapped into various views according to an aspect of the present invention. FIG. 6 depicts a list of sub-categories 601 appearing under an “Operation” view 603. Selecting a sub-category 605 results in a relevant list 607 having four documents.

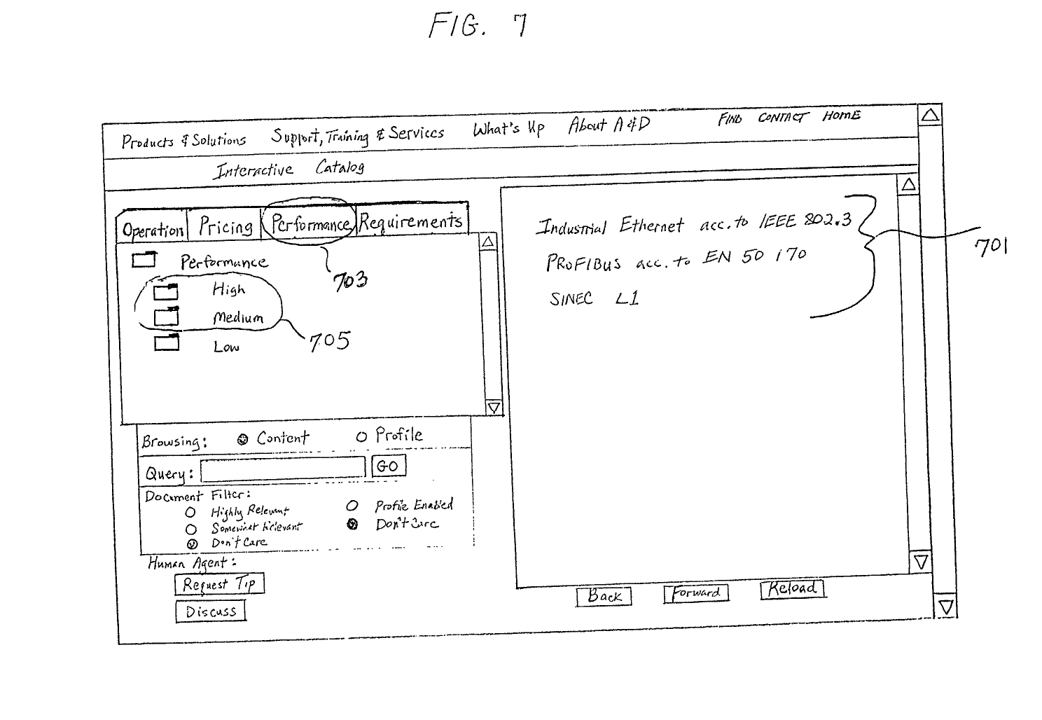

FIG. 7 shows a relevant list 701 which results from mapping the relevant list 607 into a “Performance” view 703. Here, for example, the user selects “High” and “Medium” sub-categories 705 under the “Performance” view, which results in a list of three possible product documents 701 which conform to the user's requests so far (i.e., which fit both under the sub-category 605 and the sub-categories 705.

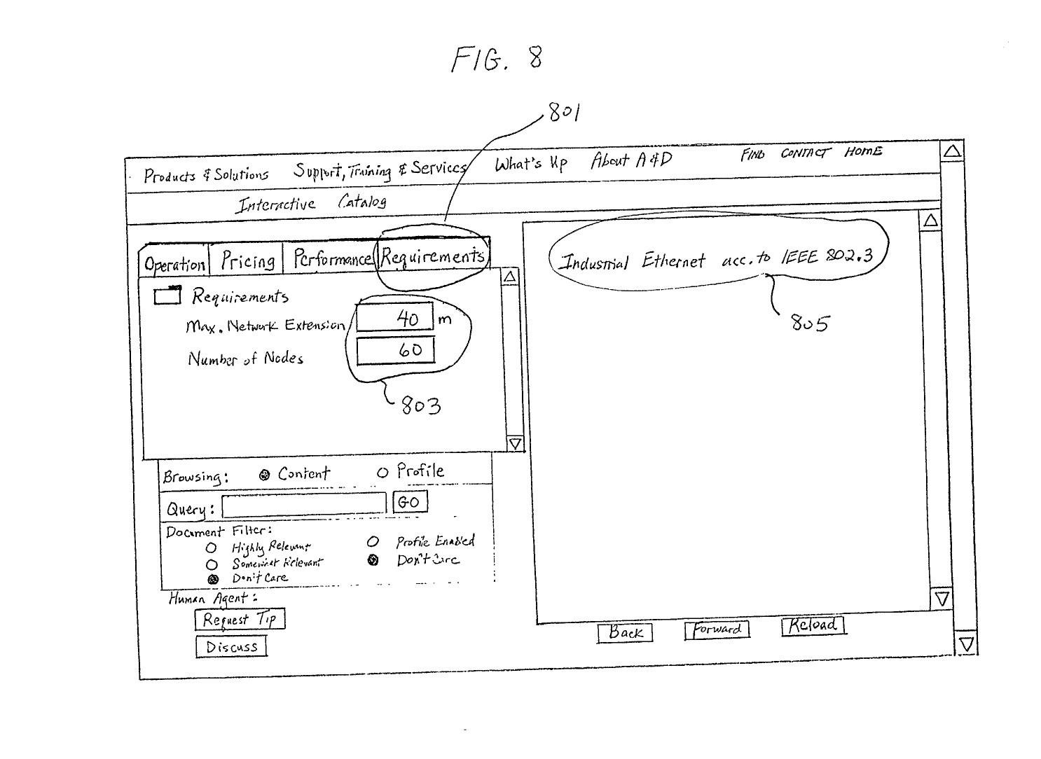

The user can further refine his/her search by selecting another view, for example, in FIG. 8 a “Requirements” view 801 is selected and specific requirements 803 desired by the user are entered. This results in narrowing down the list of relevant documents to just one document 805. In addition, it is to be appreciated that the user can go back under a previous view to further refine any desired qualities.

Advantageously, a system and method according to the present invention offers users the ability to select products or product information despite the users lack of knowledge of the details of or answers to questions about which products or product information they are looking for. The present invention enables information to be presented from_multiple perspectives that are each a unique description of the information and are cross-linked to each other.

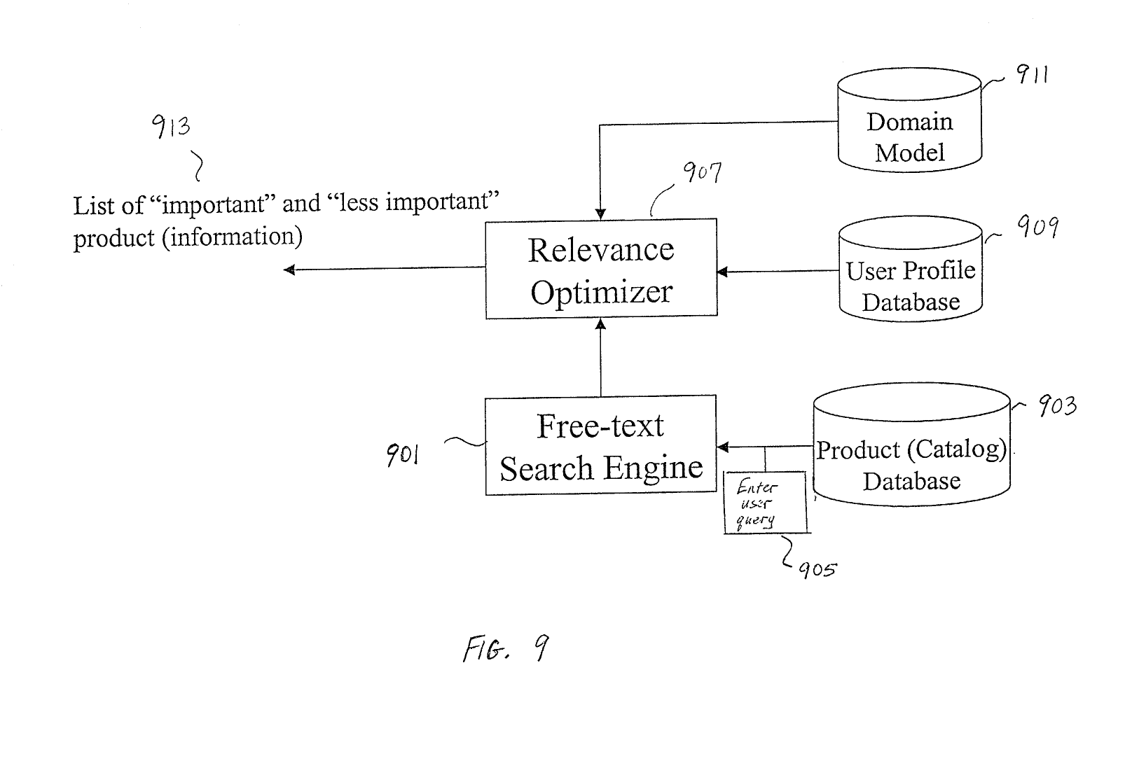

FIG. 9 is an exemplary block diagram illustrating a method for generating search results according to an aspect of the present invention. Any free-text search engine 901 can be used to find a relevant list of products or product information (for example, selected product information 202) from a product (catalog) database 903 based on an entered user query 905.

A relevance optimizer 907 then classifies the retrieved list into a list 913 of the “important” 204 and the “less important” 206 categories based on a user profile stored in a user profile database 909, and a domain model 911. The “important” 204 product information is, for example, information which is of interest to the user (based on the user profile) and which is not isolated in the domain model 911. The domain model 911 comprises a complete set of multiple views 106, each of which further includes a hierarchical list of sub-categories. Links from a list of product or product information to a set of sub-categories are created during an authoring process and stored in the product catalog database 903.

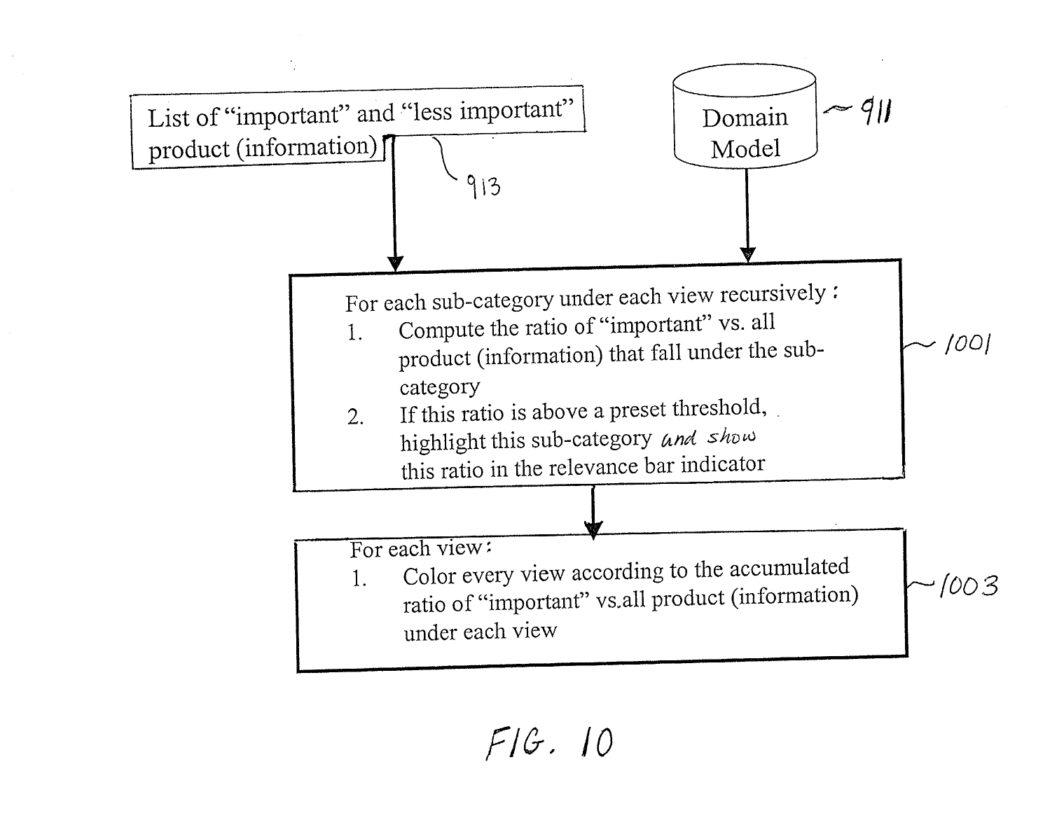

FIG. 10 depicts an exemplary block diagram depicting a method for updating the relevance of each sub-category and each view. In a preferred embodiment, the relevance of each view as well as each sub-category is determined using the list 913 and the domain model 911. Initially, the relevance of each sub-category under each view is determined in step 1001 by computing recursively the ratio of “important” vs. the total of all product information that are indexed under the sub-category. If this ratio is above a pre-determined threshold, the sub-category can be highlighted and the ratio shown using the relevance bar indicator 208. The relevance of each view can then be shown (step 1003) by altering, for example, the color, shade and/or pattern of each tab 106 according to the accumulated relevance ratios of all corresponding sub-categories under each view. Advantageously, these color (and/or shade/pattern)-coded views and highlighted sub-categories give users an idea about which views and sub-categories to look under for relevant information, thus enabling a more efficient search.

According to one aspect of the present invention, a method is provided for interactively selecting/deselecting a sub-category. The preferred embodiment allows users to select a sub-category (essentially making a sub-category relevant) or to deselect a sub-category (i.e., making a sub-category irrelevant). The former case occurs when users feel a particular sub-category contains products or product information that is very relevant to their needs. In such a case, the preferred embodiment makes all product or product information indexed under this sub-category “important”, and updates the list 913 and the relevance of each view and each sub-category accordingly (e.g., such that if a view or sub-category now contains a higher ratio of important products/product information, the relevance indicators of each view and sub-category are updated to reflect this).

In addition, if a particular sub-category is not considered relevant by a user, the user may deselect that sub-category. In this case, the preferred embodiment removes all products or product information indexed under this category from the previous list 913, and updates the selected product information 913 and the relevance of each view and each sub-category accordingly. It is to be appreciated that a sub-category can be set as relevant or not relevant (irrelevant) manually by the user as the user selects or does not select (deselects) various sub-categories. As the user manually selects or deselects a sub-category within one view, the importance of sub-categories within another view may be automatically modified to reflect the change.

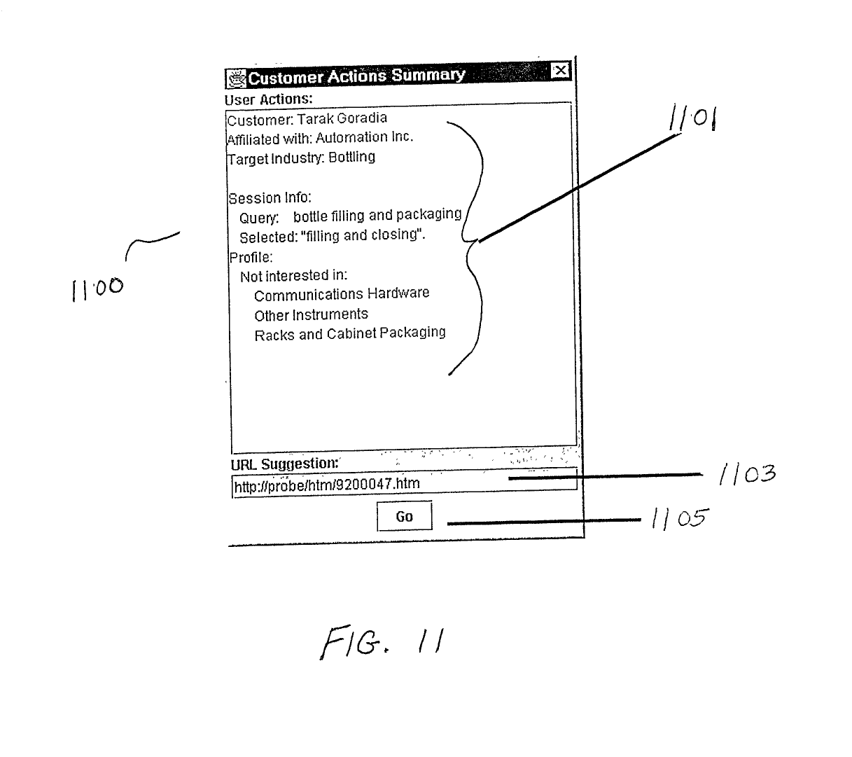

FIG. 11 depicts an exemplary user summary window 1100 showing user intention and knowledge level, which is displayed on the screen of a human agent when a user requests for either anonymous help 110 or in-person help 112. A preferred embodiment of the user summary window 1100 includes a text summary 1101, a URL field 1103, and a “Go” button 1105. The text summary 1101 displays, for example, a summary of the user's search requirements (i.e., the user's intentions and knowledge level) to assist the agent in understanding the needs of the user. If the agent finds information pertinent to the needs of the user, the agent can enter, for example, a URL field 1103 and send the URL to the user by pressing the “Go” button 1105.

Although illustrative embodiments of the present invention have been described herein with reference to the accompanying drawings, it is to be understood that the present invention is not limited to those precise embodiments, and that various other changes and modifications may be affected therein by one skilled in the art without departing from the scope or spirit of the present invention. All such changes and modifications are intended to be included within the scope of the invention as defined by the appended claims. intended to be included within the scope of the invention as defined by the appended claims.

What is claimed is:

1. A system for accessing information comprising:
a server system comprising
a product database;
a user profile database for storing user profiles; and
a domain model for modeling a set of views associated with product information stored in the product database, wherein said product database, the user profile database and the domain model are stored in a storage device; and
a client system comprising
a multi-view product browser for rendering a set of views stored in the storage device, each view comprising a perspective of product data, said product data being organized under sub-categories under each view, wherein as the user searches through the set of views, the multi-view product browser maps information from each view to other views for refining said information; and
a hypertext browser for generating relevant data from said product data based on at least one of a user query, domain knowledge, and the user profile, wherein a degree of relevance is reflected for each view, the sub-categories under each view and the relevant data with respect to the user query.

2. The system of claim 1, wherein each of the views is represented by a tab.

3. The system of claim 1, wherein when the user sets a sub-category as relevant, the relevant data indexed under the sub-category is categorized as important and the degree of relevance of each view and each sub-category is updated accordingly.

4. The system of claim 1, wherein when the user sets a sub-category as irrelevant, the relevant data indexed under the irrelevant sub-category is categorized as less important and the degree of relevance of each view and each sub-category is updated accordingly.

5. The system of claim 1, wherein the set of views is selected based on at least one of the user profile, community statistics and historical data.

6. The system of claim 1, wherein a user summary is generated for providing a summary of the user's search requirements, wherein the user summary is displayed on an agent's system when the user requests assistance.

7. A method of accessing information comprising the steps of:
rendering a set of tabs on a user interface, each tab comprising a perspective of product data, wherein said product data is organized under sub-categories under each tab;
generating relevant documents from said product data with respect to a user query, wherein a degree of relevance is reflected for each tab, the sub-categories under each tab, and the relevant documents with respect to the user query; and
locating the relevant documents under the set of tabs, wherein as a user searches through the set of tabs, information from each tab is mapped to other tabs for refining the relevant documents.

8. The method of claim 7, wherein the set of tabs are selected based on at least one of the user profile, community statistics and historical data.

9. The method of claim 7, wherein the degree of relevance of each tab is reflected by varying color shades.

10. The method of claim 7, wherein the degree of relevance of each sub-category is shown using a relevance indicator.

11. The method of claim 7, wherein the degree of relevance of the relevant documents with respect to the user query is shown by categorizing the relevant documents into important and less-important categories.

12. The method of claim 7, wherein the relevant documents are generated based on at least one of a user query, domain knowledge, and a user profile.

13. The method of claim 7, wherein the relevant documents are collected into a custom brochure.

14. The method of claim 7, wherein when the user sets a sub-category as relevant, the relevant documents indexed under the relevant sub-category are categorized as important and the degree of relevance of each tab and each sub-category is updated accordingly.

15. The method of claim 7, wherein when the user sets a sub-category as irrelevant, the relevant documents indexed under the irrelevant sub-category are categorized as less important and the degree of relevance of each tab and each sub-category is updated accordingly.

16. The method of claim 10, wherein the relevance indicator comprises a bar which is shaded in to show a ratio of relevant product information with respect to all product information indexed under each sub-category.

17. The method of claim 10, wherein actions of each user are summarized in a user summary, wherein if the user clicks on a help button provided on the user interface, said user summary is displayed to an agent.

18. A method of accessing information comprising the steps of:
rendering a set of tabs on a user interface, each tab representing a perspective of information of a product line, wherein as a user searches through the set of tabs, information from each tab is mapped to other tabs for refining said information; and
summarizing actions of each user in a user summary, wherein if the user clicks on a help button provided on the user interface, said user summary is displayed to an agent.

19. The method of claim 18, wherein the set of tabs are selected based on at least one of a user profile, community statistics, and historical data.

20. A program storage device readable by a machine, tangibly embodying a program of instructions executable by the machine to perform the method steps for accessing information comprising the steps of:
rendering a set of tabs on a user interface, each tab comprising a perspective of product data, wherein said product data is organized under sub-categories under each tab;
generating relevant documents from said product data with respect to a user query, wherein a degree of relevance is reflected for each tab, the sub-categories under each tab, and the relevant documents with respect to the user query; and
locating the relevant documents under the set of tabs, wherein as a user searches through the set of tabs, information from each tab is mapped to other tabs for refining the relevant documents.

21. The program storage device of claim 20, wherein the set of tabs are selected based on at least one of the user profile, community statistics and historical data.

22. The program storage device of claim 20, wherein the degree of relevance of each tab is reflected by varying color shades.

23. The program storage device of claim 20, wherein the degree of relevance of each sub-category is shown using a relevance indicator.

24. The program storage device of claim 20, wherein the degree of relevance of the relevant documents with respect to the user query is shown by categorizing the relevant documents into important and less-important categories.

25. The program storage device of claim 20, wherein the relevant documents are generated based on at least one of a user query, domain knowledge, and a user profile.

26. The program storage device of claim 20, wherein the relevant documents are collected into a custom brochure.

27. The program storage device of claim 20, wherein when the user sets a sub-category as relevant, the relevant documents indexed under the relevant sub-category are categorized as important and the degree of relevance of each tab and each sub-category is updated accordingly.

28. The program storage device of claim 20, wherein when the user sets a sub-category as irrelevant, the relevant documents indexed under the irrelevant sub-category are categorized as less important and the degree of relevance of each tab and each sub-category is updated accordingly.

29. The program storage device of claim 23, wherein the relevance indicator comprises a bar which is shaded in to show a ratio of relevant product information with respect to all product information indexed under each sub-category.
